(19) United States
(12) Patent Application Publication
(10) Pub. No.: US 2026/0368360 A1
(43) Pub. Date: Nov. 19, 2026

(54) Automated Privilege Review Using Generative Artificial Intelligence

(71) Applicant: RELATIVITY ODA LLC., Chicago, IL (US)

(72) Inventors: Aron Ahmadia, Arlington, VA (US); Somya Anand, Vancouver (CA); Sai Aravind Sreeramadas, Chicago, IL (US); Roman Van Der Krogt, Chicago, IL (US); Piyush Ghai, Chicago, IL (US); Peter Haller, Chicago, IL (US); Nathan Reff, Rochester, NY (US); Bryce Lew, Chicago, IL (US)

(21) Appl. No.: 19/651,337

(22) Filed: Apr. 17, 2026

Related U.S. Application Data
(60) Provisional application No. 63/790,868, filed on Apr. 18, 2025.

(51) Int. Cl. G06F 21/62; G06N 5/04

(52) U.S. Cl. CPC G06F 21/6254; G06N 5/04; G06F 2221/2141

(57) ABSTRACT

Techniques for automated privilege review of document families using machine learning (ML) models are provided. A method includes retrieving a document family comprising a plurality of related documents, identifying one or more entities associated with the document family and a role classification for at least one entity, generating respective privilege prediction prompts for one or more documents of the document family, inputting the respective privilege prediction prompts into a trained ML language model to generate respective privilege prediction scores, aggregating the respective privilege prediction scores to generate a family privilege assessment, and generating a family privilege log entry including the family privilege assessment and the respective privilege prediction scores.

### CROSS-REFERENCE TO RELATED APPLICATIONS

This application claims priority to U.S. Provisional Patent Application No. 63/790,868, entitled “AUTOMATED PRIVILEGE REVIEW USING GENERATIVE ARTIFICIAL INTELLIGENCE,” filed on Apr. 18, 2025, the entire contents of which are hereby incorporated by reference.

### FIELD OF THE DISCLOSURE

The present disclosure relates generally to reviewing documents for privilege, and more particularly, to utilizing machine learning models to identify, prioritize, and review potentially privileged documents.

### BACKGROUND

In the realm of legal document analysis, there is a need to streamline the typically labor-intensive and time-consuming task of privilege review, which includes identifying potential attorney-client, work product, and/or common interest communications and determining their privileged status. Challenges in automated privilege review analysis include achieving high precision and recall rates, minimizing the risk of inadvertently disclosing privileged information, dealing with the complexities of legal language, handling the variability in how attorneys are referenced, classifying the roles of entities referenced in documents, and addressing the context-dependent nature of privilege, including privilege characteristics shared across documents. Moreover, the process of generating privilege logs requires not only the identification of privileged documents but also an explanation of the basis for their privileged status—a task that demands a nuanced understanding of legal concepts and the ability to extract relevant information from unstructured text.

In view of the foregoing challenges, there is a need for systems and methods for automated privilege review.

### BRIEF SUMMARY

In one aspect, a computer-implemented method for performing automated privilege review using a trained machine learning (ML) language model is provided. The computer-implemented method may include: (i) retrieving, by one or more processors, a document family comprising a plurality of related documents having document text; (ii) identifying, by the one or more processors, one or more entities associated with the document family and a role classification for at least one of the entities; (iii) generating, by the one or more processors, respective privilege prediction prompts for one or more documents of the document family, the respective privilege prediction prompts including at least a portion of the document text, indications of the one or more entities, the role classification, and a review protocol including privilege prediction instructions; (iv) inputting, by the one or more processors, the respective privilege prediction prompts into the trained ML language model, causing the trained ML language model to generate respective privilege prediction scores for the one or more documents; (v) aggregating, by the one or more processors, the respective privilege prediction scores to generate a family privilege assessment; and (vi) generating, by the one or more processors, a family privilege log entry including the family privilege assessment and the respective privilege prediction scores.

In another aspect, a system for performing automated privilege review using a trained machine learning (ML) language model is provided. The system may include one or more processors and one or more non-transitory memories storing computer-executable instructions that, when executed by the one or more processors, cause the system to: (i) retrieve a document family comprising a plurality of related documents having document text; (ii) identify one or more entities associated with the document family and a role classification for at least one of the entities; (iii) generate respective privilege prediction prompts for one or more documents of the document family, the respective privilege prediction prompts including at least a portion of the document text, indications of the one or more entities, the role classification, and a review protocol including privilege prediction instructions; (iv) input the respective privilege prediction prompts into the trained ML language model, causing the trained ML language model to generate respective privilege prediction scores for the one or more documents; (v) aggregate the respective privilege prediction scores to generate a family privilege assessment; and (vi) generate a family privilege log entry including the family privilege assessment and the respective privilege prediction scores.

In yet another aspect, a non-transitory computer-readable medium storing computer-executable instructions for performing automated privilege review using a trained machine learning (ML) language model is provided. When executed by one or more processors, the computer-executable instructions may cause the one or more processors to: (i) retrieve a document family comprising a plurality of related documents having document text; (ii) identify one or more entities associated with the document family and a role classification for at least one of the entities; (iii) generate respective privilege prediction prompts for one or more documents of the document family, the respective privilege prediction prompts including at least a portion of the document text, indications of the one or more entities, the role classification, and a review protocol including privilege prediction instructions; (iv) input the respective privilege prediction prompts into the trained ML language model, causing the trained ML language model to generate respective privilege prediction scores for the one or more documents; (v) aggregate the respective privilege prediction scores to generate a family privilege assessment; and (vi) generate a family privilege log entry including the family privilege assessment and the respective privilege prediction scores.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. There are shown in the figures arrangements which are presently discussed; it being understood, however, that the present embodiments are not limited to the precise arrangements and instrumentalities shown.

FIG. 1 illustrates an example computer environment that may be used to implement the techniques for automated privilege review, according to an embodiment.

FIG. 2 illustrates an example computer system that may be used to implement the techniques for automated privilege review, according to an embodiment.

FIG. 3A illustrates an example process for document retrieval, according to an embodiment.

FIG. 3B illustrates an example process for document extraction, according to an embodiment.

FIG. 3C illustrates an example process for entity identification and role classification, according to an embodiment.

FIG. 3D illustrates an example process for privilege prediction and logging, according to an embodiment.

FIG. 3E illustrates an example process for family-level privilege analysis, according to an embodiment.

FIG. 4 illustrates an example social network knowledge graph, according to an embodiment.

FIG. 5 illustrates an example entity review user interface, according to an embodiment.

FIG. 6 illustrates an example privilege review user interface, according to an embodiment.

FIG. 7 illustrates an example computer-implemented method for automated privilege review.

FIG. 8 illustrates an example computer-implemented method for family-level automated privilege review.

FIG. 9 illustrates an example computer-implemented method for prompt-based role identification.

### DETAILED DESCRIPTION

### Overview and Advantages

The following relates to systems and methods designed to perform automated privilege review using trained machine learning (ML) language models. The disclosed techniques address the complex and time-consuming task of identifying privileged documents within large datasets. By automating the identification and prioritization of potentially privileged documents, the disclosed techniques may reduce the risk, cost, and time associated with manual privilege review.

In some implementations, the systems and methods automate first-pass privilege review. This process may involve cleansing data, identifying individuals and their privilege conferring status, extracting potentially privileged snippets of text, and/or delivering prioritized privileged documents to reviewer queues. ML language models may enable the systems and methods to understand complex language and identify nuances that indicate the privileged nature of content. This capability not only streamlines the review process but also enhances precision in identifying privileged documents, thereby reducing the likelihood of overlooking critical information.

In some implementations, the systems and methods extract disclaimers within documents and generate privilege predictions based in part on the extracted disclaimers. Disclaimers often contain information that can influence the determination of a document’s privileged status. For some analyses, this influence is desired. For other analyses, this influence may bias a model and should be omitted. By automating the extraction and detection of disclaimers, the systems and methods may process the disclaimers in an appropriate manner for that analysis. This automation may include predictions on individuals’ roles and privilege statuses, as well as on document snippets indicating privileged content. Such comprehensive analysis may refine the selection of documents for review, prioritizing the most relevant documents for manual review.

In some implementations, the systems and methods classify the roles of entities referenced in documents. A document may reference an entity by name, email address, or alias without indicating whether that entity is an attorney or holds another role relevant to privilege . For example, an email addressed to “John Fischer” may not indicate whether John Fischer is outside counsel, in-house counsel, opposing counsel, or a non-legal client employee. Without role information, an ML language model analyzing the document may be unable to determine whether the communication involves a privilege-conferring role. The systems and methods may obtain supplemental information about the entity from sources external to the document (e.g., web pages, organization charts, legal bar directories, and/or professional networking sites). By incorporating the supplemental entity information into a role classification prompt along with an indication of the entity and role classification instructions, the systems and methods may enable an ML language model to generate role classifications for entities even when there are no explicit role indicators available within the four corners of the document.

The systems and methods may generate a role classification prompt that combines an indication of the entity, the supplemental entity information obtained from external sources, and/or role classification instructions. ML language models may analyze this combined information to generate a role classification, such as whether the entity holds a legal role (e.g., outside counsel, in-house counsel, or opposing counsel) or a non-legal role (e.g., non-legal client employee, vendor, or third-party). By structuring the role classification prompt to include both the indication of the entity and the supplemental entity information obtained from external sources, the systems and methods may enable the ML language model to analyze information from external sources. By incorporating the supplemental entity information into the role classification prompt, the systems and methods may classify entities even when the document itself lacks explicit role indicators. Because privilege determinations depend on whether communications involve individuals in privilege-conferring roles, accurate role classification may improve the accuracy of downstream privilege determinations.

The systems and methods may store the generated role classification in an entity profile maintained in a data store. In some implementations, the systems and methods may compare a newly generated role classification to an existing role classification in the entity profile and, responsive to determining that the newly generated role classification includes a higher likelihood of privilege association than the existing role classification, replace the existing role classification with the newly generated role classification. For example, if an entity was initially classified as a non-legal client employee based on a document lacking role indicators, but a subsequent document containing an email signature identifies the entity as outside counsel, the systems and methods may update the entity profile to reflect the more privilege-relevant classification. The systems and methods may include the role classification from the entity profile in privilege prediction prompts for subsequent documents referencing that entity, which may improve the accuracy of privilege predictions by providing the ML language model with role information derived from prior document analysis.

In some implementations, the systems and methods identify a second entity referenced in the document, determine a relationship between the first entity and the second entity, and determine a role classification for the second entity based in part on the relationship. External sources may not contain information about every entity referenced in a document. For example, a junior associate at a law firm may not appear in legal bar directories or have a professional networking profile. By leveraging relationship data derived from document analysis (e.g., co-occurrence with a known outside counsel or organizational affiliation indicated in an email signature), the systems and methods may generate role classifications for entities described in such external sources that lack the underlying information that would otherwise be necessary to determine an entity’s role . This relationship-based inference may extend the coverage of role classification across the corpus, which may improve the recall of privilege predictions for documents referencing entities that would otherwise lack role information.

The role classification instructions may instruct the ML language model to cross-validate the indication of the entity against the supplemental entity information before generating the role classification. For example, if the document references “John Fischer” and the supplemental entity information includes a bar directory listing for "Jonathan Fischer, Esq.," the role classification instructions may instruct the ML language model to determine whether "John Fischer" and "Jonathan Fischer" refer to the same individual before relying on the bar directory listing to classify the entity as outside counsel. This cross-validation may reduce errors caused by entity name collisions (e.g., where multiple individuals share similar names) by ensuring that the supplemental entity information corresponds to the correct entity before the ML language model relies on that information to generate the role classification that underpins, for example, a privilege determination.

In some implementations, the systems and methods analyze document families (e.g., collections of related documents such as email threads comprising a plurality of email messages, emails with one or more attachments, or parent documents with linked child documents). Documents within a family may share privilege characteristics that are not apparent when each document is analyzed independently. For example, an attachment may derive its privilege status from the enclosing email that requests legal advice, even if the attachment itself contains no privileged language. Conversely, an earlier email in a thread may contain privileged legal advice, but a subsequent email may forward that advice to a third party, potentially affecting the privilege status of the entire thread. By analyzing documents in the context of their family relationships, the systems and methods may detect privilege characteristics that propagate across documents (including privilege breakers that affect the entire family), which may improve the accuracy of privilege predictions compared to analyzing each document in isolation.

In some implementations, the systems and methods may generate respective privilege prediction prompts for each document in the document family to first be able to detect a privilege based on document itself. Then an additional privilege prediction prompt may include the outputs of the individual pass through the family documents to generate and/or update the privilege prediction for each family member based on relational data between the documents. This structured context may improve the accuracy of the ML language model's privilege predictions by enabling the ML language model to detect privilege propagation (e.g., an attachment deriving privilege from its enclosing email, subject matter based privilege based on context derived from other documents in the family, etc.) or privilege waiver (e.g., a subsequent email forwarding privileged content to a third party) that would not be detectable if each document were analyzed in isolation.

In some implementations, the systems and methods may query a knowledge base to retrieve privilege-related information associated with one or more entities and include privilege-related information in one or more privilege prediction prompts. The knowledge base may contain a "universal knowledge base" containing information and models built on publicly accessible data, a “client knowledge base” containing knowledge learned from each past matter, and/or a “matter knowledge base” that contains case-specific learnings. Privilege-related information retrieved from the knowledge bases may include role classifications, organizational affiliations, and/or entity relationships derived from prior analyses. This multi-layered knowledge base may provide consistency across all future matters and enable the system or method to adapt and improve over time.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Additional, alternate and/or fewer actions, steps, features and/or functionality may be included in an aspect and/or embodiments, including those described elsewhere herein. Accordingly, the drawings and description are to be regarded as illustrative in nature and not as restrictive.

### Example Computing Environment and Computer System

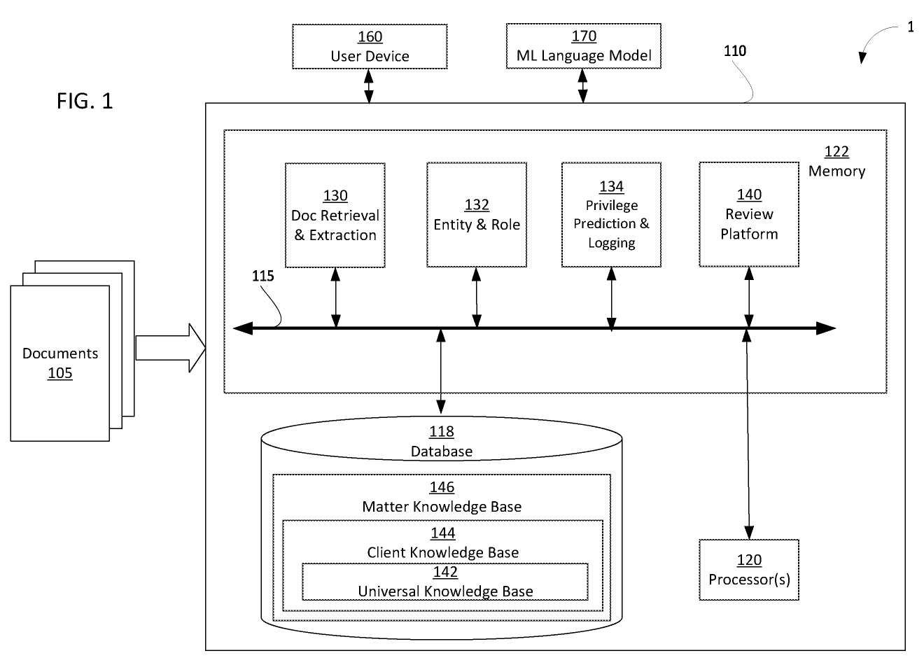

FIG. 1 illustrates an exemplary computer environment 100 for using an ML language model to: (i) predict the privilege status of documents, and/or (ii) generate a privilege log. The high-level architecture includes both hardware and software applications, as well as various data communications channels for communicating data between the various hardware and software components.

As illustrated, the computing environment 100 includes a workspace 110 associated with a corpus of documents 105, such as a set of documents associated with an eDiscovery project. Such documents in the corpus of documents 105 may have a plurality of file types. Examples of the file type include: an email file, a word processing file, a spreadsheet file, an audio recording, image data (e.g., image and/or video data), a text message, etc.

The workspace 110 and/or the components thereof may be implemented as software modules within a cloud and/or distributed computing system (e.g., Amazon Web Services (AWS) or Microsoft Azure). Accordingly, the components of the workspace 110 may include separate logical addresses via which the components are accessible via a bus 115 or other messaging channel supported by the cloud computing system. In some embodiments, the workspace 110 includes multiple instances of the same component to increase the ability for parallelization for the various functions performed via the respective components.

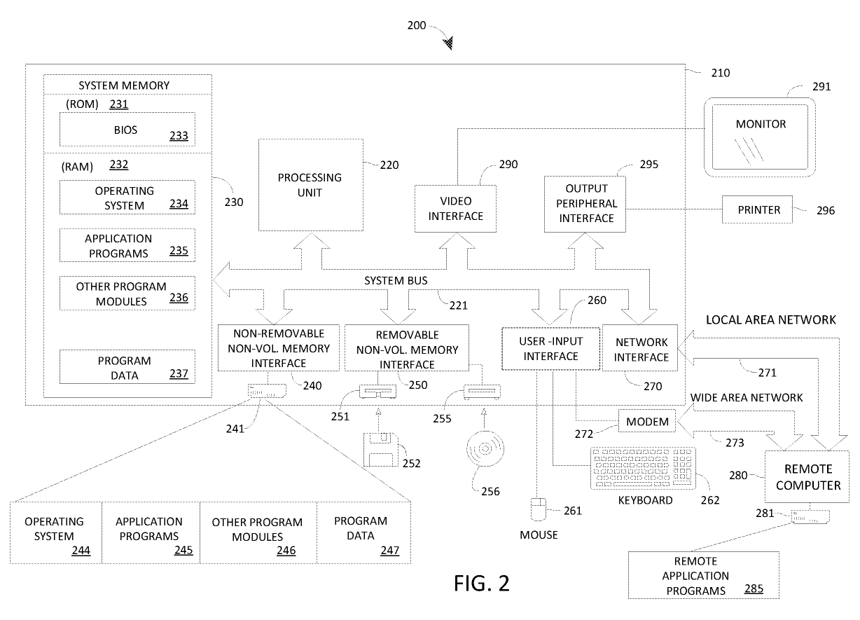

To implement the computing environment 100, a computing system may be used, such as computing system 200 of the example of FIG. 2, to host and/or execute at least a portion of the workspace 110. The computing system 200 may include a computer 210. Components of the computer 210 may include, but are not limited to, a processing unit 220, a system memory 230, and a system bus 221 that couples various system components including the system memory 230 to the processing unit 220. In some embodiments, the processing unit 220 may include one or more parallel processing units capable of processing data in parallel with one another. The system bus 221 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 210 may include a variety of computer-readable media. Computer-readable media may be any available media that can be accessed by computer 210 and may include both volatile and nonvolatile media, and both removable and non-removable media. By way of example, and not limitation, computer-readable media may comprise computer storage media and communication media. Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 210.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to, and/or presently being operated on, by processing unit 220. By way of example, and not limitation, FIG. 2 illustrates operating system 234, application programs 235, other program modules 236, and program data 237. For example, the application programs 235, the program modules 236, and/or the program data 237 may include any of the applications executed within the workspace 110.

The computer 210 may also include other removable/non-removable, volatile/nonvolatile computer storage media. By way of example only, FIG. 2 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 may be connected to the system bus 221 through a non-removable memory interface such as interface 240, and magnetic disk drive 251 and optical disk drive 255 may be connected to the system bus 221 by a removable memory interface, such as interface 250.

The drives and their associated computer storage media discussed above and illustrated in FIG. 2 provide storage of computer-readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as cursor control device 261 (e.g., a mouse, trackball, touch pad, etc.) and keyboard 262. A monitor 291 or other type of display device is also connected to the system bus 221 via an interface, such as a video interface 290. In addition to the monitor, computers may also include other peripheral output devices such as printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and may include many or all of the elements described above relative to the computer 210, although only a memory storage device 281 has been illustrated in FIG. 2. The logical connections depicted in FIG. 2 include a local area network (LAN) 271 and a wide area network (WAN) 273 but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 may include a modem 272 or other means for establishing communications over the WAN 273, such as the Internet. The modem 272, which may be internal or external, may be connected to the system bus 221 via the input interface 260, or other appropriate mechanism. The communications connections 270, 272, which allow the device to communicate with other devices, are an example of communication media, as discussed above. In a networked environment, program modules depicted relative to the computer 210, or portions thereof, may be stored in the remote memory storage device 281. By way of example and not limitation, FIG. 2 illustrates remote application programs 285 as residing on memory device 281.

In some embodiments, the computing system 200 is a server computing system communicatively coupled to a local workstation (e.g., a remote computer 280) via which a user interfaces with the computing system 200. For example, the computer 210 may be configured to present one or more user interfaces at a local workstation (e.g., a client device) for presentation thereat to receive descriptions of the classification model and/or to present outputs of the prompt-based classification model.

In some embodiments, the computing system 200 may include any number of computers 210 configured in a cloud or distributed computing arrangement. Accordingly, the computing system 200 may include a cloud computing manager system (not depicted) that efficiently distributes the performance of the functions described herein between the computers 210 based on, for example, a resource availability of the respective processing units 220 or system memories 230 of the computers 210. In these embodiments, the documents in the corpus of documents and/or the data associated with a ML language model may be stored in a cloud or distributed storage system (not depicted) accessible via the interfaces 271 or 273. Accordingly, the computer 210 may communicate with the cloud storage system to access the documents within the corpus of documents, for example, when generating an embedding vector as part of the model training process.

As illustrated in FIG. 1, the workspace 110 includes various modules that can be executed within the workspace 110, each module being a respective set of computer-executable instructions. For example, workspace 110 may include a document retrieval and extraction module 130, an entity and role module 132, a privilege prediction and logging module 134, and a review platform module 140. In operation, the modules executing within the workspace 110 may be configured to facilitate automated privilege review of documents in the corpus of documents 105.

The document retrieval and extraction module 130 supports operations for retrieving documents from the corpus of documents 105 for review. The document retrieval and extraction module 130 may retrieve documents from one or more locations, including a local database 118 and/or a remote storage system (not depicted), such as a data lake or other cloud-storage system. The document retrieval and extraction module 130 extracts text from the documents for analysis. In some embodiments, the document retrieval and extraction module 130 performs optical character recognition (OCR) to extract text data from images or scanned documents. In some embodiments, the document retrieval and extraction module 130 transcribes speech from audio and/or video into text data. The document retrieval and extraction module 130 may extract metadata from the documents for analysis. In some embodiments, the document retrieval and extraction module 130 extracts legal disclaimers and/or email signatures from the documents. The entity and role module 132 may input a legal disclaimer and signature identification prompt into the ML language model 170 and receive a response from the ML language model 170. It should be appreciated that for other analysis, the disclaimer may be omitted when the document is input into a machine learning model.

The entity and role module 132 identifies one or more entities associated with the document using named entity recognition (NER). Entities may include names, email addresses, aliases, and/or other identifiers in the body and/or metadata of a document. The entity may be associated with an individual, law firm, business, or other organization. The entity and role module 132 assigns a role classification to one or more of the identified entities. For example, role classifications may include outside counsel, in-house counsel, opposing counsel, non-legal client employee, vendor, third-party, etc. In some embodiments, the entity and role module 132 inputs an entity identification prompt into the ML language model 170 and receives a response from the ML language model 170. As another example, legal entities may be detected using the machine learning techniques described in U.S. Patent Application 18/131,819 filed Apr. 6, 2023, the entire contents of which are hereby incorporated by reference.

The privilege prediction and logging module 134 generates a privilege prediction prompt using retrieval augmented generation (RAG) or other similar retrieval techniques. As will be explained below, the retrieval techniques may utilize the corresponding access privileges to the knowledge maintained in the database 118 when accessing documents for injection into a prompt. The privilege prediction prompt may include portions of the document text, document metadata, parent metadata, identified entities, role classifications, and/or a review protocol. As such, despite the reference to RAG herein, the retrieval techniques may only inject metadata extracted from retrieved documents into the prompt without injecting the document itself. The privilege prediction and logging module 134 inputs this privilege prediction prompt into the ML language model 170 and receives a response from the ML language model 170.

The review platform module 140 facilitates manual review of any documents. In some embodiments, the review platform module 140 may be configured to present one or more graphical user interface (GUIs) on the user device 160. Accordingly, the review platform module 140 and the user device 160 may be communicatively coupled via one or more communication networks. For example, the communication networks may include one or more wired and/or wireless local area networks (LANs) and/or one or more wired and/or wireless wide area networks (WANs), such as the Internet.

The workspace 110 includes or has access to a database 118. One or more of the software modules may store and/or retrieve information from the database 118. The database 118 may include a relational database, (such as Oracle, DB2, or MySQL), a NoSQL based database (such as MongoDB), a vector database (such as Pinecone or LlamaIndex), and/or a graph database (such as Neo4j or ArangoGraph). In some embodiments, the database 118 includes a universal knowledge base 142, a client knowledge base 144, and a matter knowledge base 146. The “universal knowledge base” 142 includes information from publicly accessible sources (e.g., entity websites, Wikipedia pages, etc.). The “client knowledge base” 144 includes knowledge obtained from one or more workspaces associated with past matters for that client to promote consistency and learning across present and future matters for the client. The “matter knowledge base” 146 includes case-specific knowledge derived from documents analyzed via the workspace 110 to maintain a body of knowledge derived from the ingested documents 105.

In some embodiments, the privilege prediction and logging module 134 queries the knowledge bases 142-146 to retrieve privilege-related information associated with one or more entities and includes the privilege-related information in one or more privilege prediction prompts. The privilege prediction and logging module 134 may query the knowledge bases 142-146 using retrieval techniques such as semantic similarity search, keyword-based matching, or graph traversal based on the identified entities and/or role classifications. Privilege-related information retrieved from the knowledge bases 142-146 may include role classifications, organizational affiliations, entity relationships derived from prior analyses, historical privilege determinations involving the entity, and/or communication patterns between entities. For example, if the knowledge base indicates that a particular entity has previously been involved in privileged attorney-client communications, this information may be included in the privilege prediction prompt to inform the ML language model's analysis. The privilege prediction and logging module 134 may include the retrieved privilege-related information in the privilege prediction prompt as context for the trained ML language model, which may improve the accuracy of privilege predictions by providing the ML language model with information beyond the four corners of the document being analyzed.

The example computing environment 100 includes or has access to an ML language model 170, which may include a large language model (LLM) (such as Claude, Gemini, GPT, Llama, DeepSeek, and so on). The ML language model 170 accepts text-based prompts as input and generates text-based responsive outputs. In some embodiments, the ML language model 170 may include architectural features that improve chain of thought reasoning by selectively activating portions of the model based on the input to the model. In some instances, these specialized architectural features may result in the ML language model 170 being a “reasoning model.” It should be appreciated that while the ML language model 170 is depicted as being external to the workspace 110, in some embodiments, at least a portion of the model data associated with the ML language model 170 is maintained within the workspace 110.

In some embodiments, the ML language model 170 is a pre-trained language model that has been fine-tuned on privilege-related training data. The training data may include labeled examples of privileged and non-privileged documents, annotated privilege log entries, and/or examples of role classifications for entities. In some embodiments, the ML language model 170 is fine-tuned using supervised learning techniques, wherein the training data includes human-annotated privilege determinations. In some embodiments, the ML language model 170 is fine-tuned using reinforcement learning from human feedback (RLHF), wherein human reviewers provide feedback on model outputs to improve privilege prediction accuracy. The training data may be derived from the universal knowledge base 142, the client knowledge base 144, and/or the matter knowledge base 146. In some embodiments, the ML language model 170 is a foundation model that has not been fine-tuned on privilege-specific data, and the privilege prediction and logging module 134 provides privilege-specific context via the privilege prediction prompt (e.g., few-shot examples, review protocols, and/or privilege determination instructions).

Furthermore, although the example computing environment 100 illustrates only one of each of the components, any number of the example components are contemplated (e.g., any number of computing devices, user devices, databases, etc.).

### Example Processes

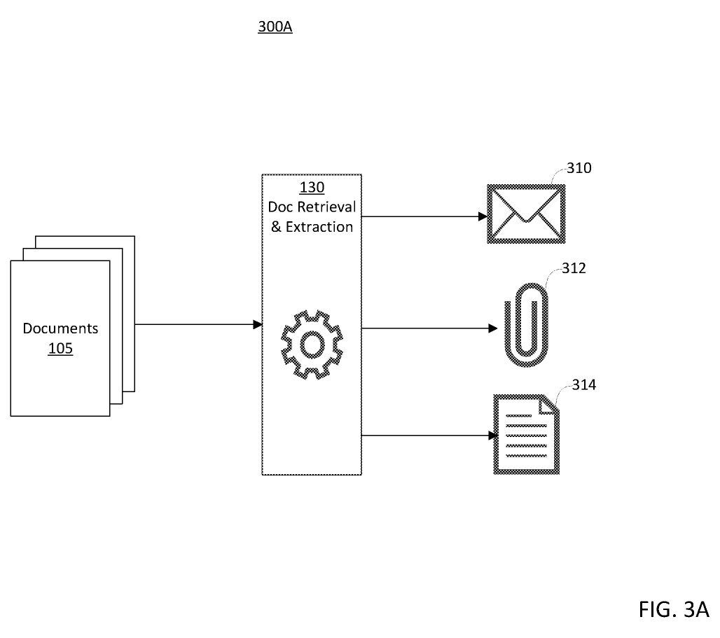

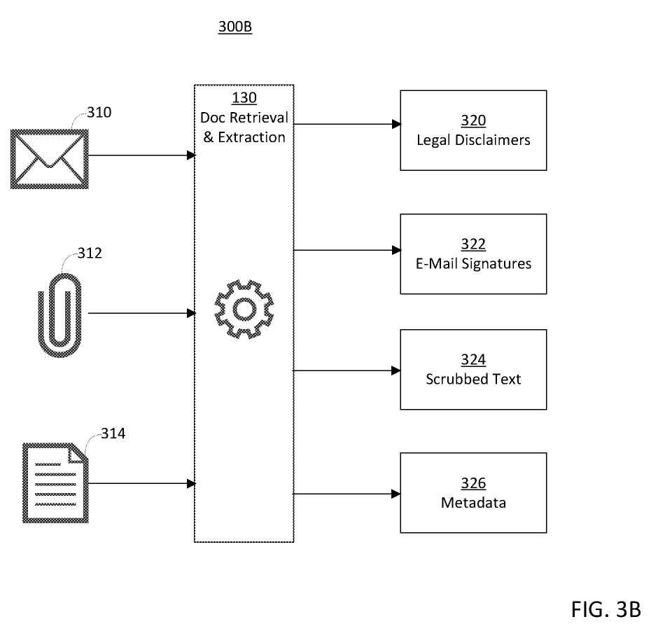

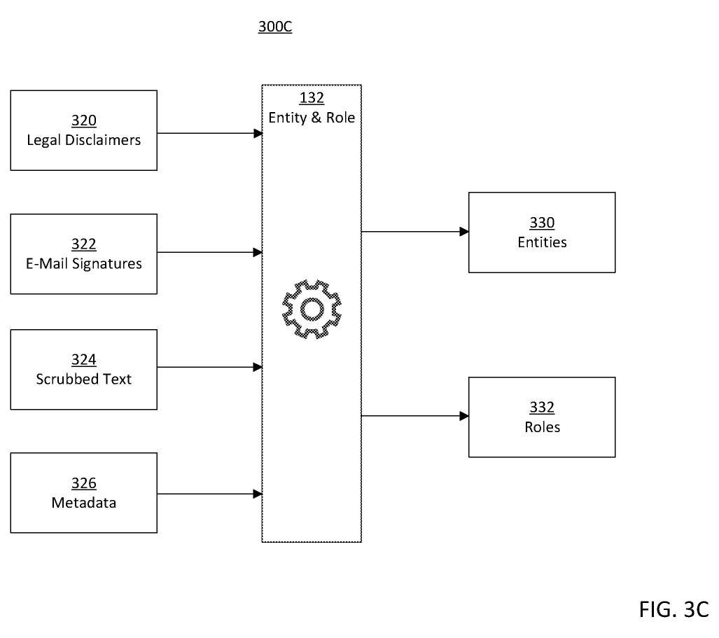

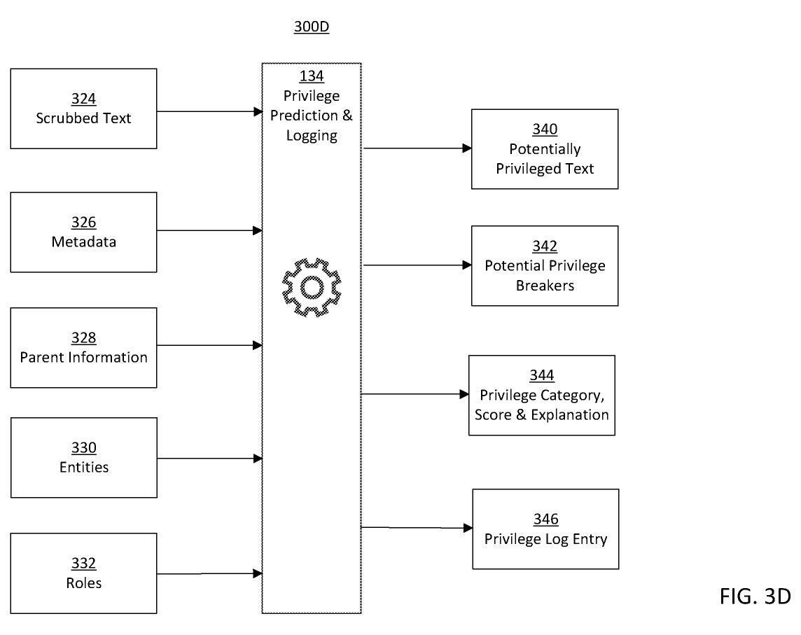

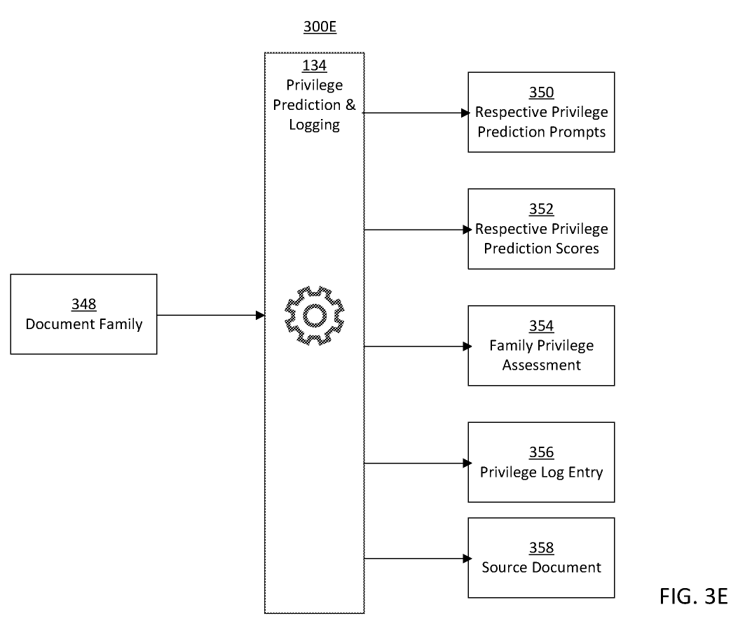

FIG. 3A depicts an exemplary process 300A associated with document retrieval. The document retrieval and extraction module 130 retrieves a document batch, including one or more documents, from the corpus of documents 105. In some embodiments, the document batch is manually selected by a user. In other embodiments, the document retrieval and extraction module 130 automatically selects the document batch based on one or more criteria, such as document size, family relationships, etc. The document retrieval and extraction module 130 may identify and discard spam email messages based on known spammer email addresses, message content, and/or other techniques. The document retrieval and extraction module 130 module outputs one or more email messages 310, email attachments 312, and/or standalone documents 314.

FIG. 3B depicts an exemplary process 300B associated with document extraction. The document retrieval and extraction module 130 processes an email message 310, an email attachment 312, or a standalone document 314. In some embodiments, the document retrieval and extraction module 130 may convert images, audio, or video content in the email attachment 312 or the standalone document 314 into text data.

The document retrieval and extraction module 130 may identify and extract any legal disclaimers 320 from the email message 310, the email attachment 312, or the standalone document 314. An example of a legal disclaimer 320 includes, “This message, including any attachments, may contain proprietary, confidential, or privileged information and is intended only for the designated recipient(s) named above.” Legal disclaimers 320 may include legal language that may be misinterpreted by the ML language model 170 as legal advice. In some embodiments, the legal disclaimers 320 are presented to a user to confirm or deny the identified disclaimer language. The document retrieval and extraction module 130 may identify and extract any email signatures 322 from an email message 310. In some embodiments, the document retrieval and extraction module 130 matches keywords, known legal disclaimers 320, and/or known email signatures 322 from the database 118 to identify a legal disclaimer 320 and/or email signature 322. In some embodiments, the document retrieval and extraction module 130 may send to the ML language model 170 one or more prompts that include some or all of text data from the email message 310, the email attachment 312, or the standalone document 314 and instructions to identify any legal disclaimers 320 and/or email signatures 322. The one or more prompts may be few shot prompts that include one or more examples of legal disclaimers 320 and/or email signatures 322.

The document retrieval and extraction module 130 may output scrubbed text 324 from the email message 310, email attachment 312, or standalone document 314. The scrubbed text 324 may include text data from the body of the document with any legal disclaimers 320 or email signatures 322 removed. The document retrieval and extraction module 130 may output metadata 326 from the email message 310, email attachment 312, or standalone document 314. Metadata 326 may include a document author, document filename, email addresses, email subject, etc.

FIG. 3C depicts an exemplary process 300C associated with entity identification and role classification. The entity and role module 132 receives as input the scrubbed text 324 and metadata 326. In some embodiments, the entity and role module 132 may receive legal disclaimers 320 and/or email signatures 322. The entity and role module 132 analyzes at least one of semantic content or document attributes of the document to identify one or more entities. For example, the entity and role module 132 recognizes a name or other reference to an entity in the scrubbed text 324 (semantic content) or a name or email address in the metadata 326 (document attributes). In some embodiments, the entity and role module 132 identifies entities using NER and/or other techniques as described above. The entity and role module 132 outputs identified entities 330 and/or roles 332 assigned to the identified entities.

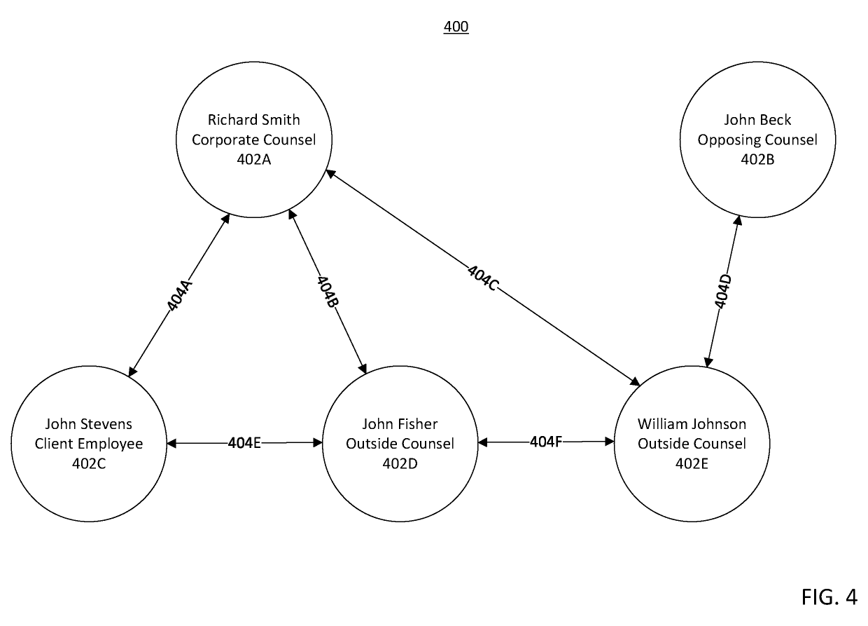

The entity and role module 132 may reference senders and recipients in an analyzed email or another email in an email thread to disambiguate a name or other entity reference. For example, a mention of “Steven” in the body of an email may refer to “Steven Washington,” who was a recipient of an earlier email in the email thread. The entity and role module 132 may also disambiguate entity references using the social knowledge graph, as described below with respect to FIG. 4.

In some embodiments, the entity and role module 132 generates an entity identification prompt using retrieval techniques with respect to entity objects associated with the identified entities. The entity and role module 132 may query the database 118 (and/or knowledge stored in the knowledge bases 142-146) to retrieve an entity object 330 associated with the name, email address, or other reference. As used herein, an “entity object” 330 refers to a data structure maintained in the database 118 for a known entity. Each entity object 330 may include an “entity profile” having one or more data fields indicative of a full name, one or more email addresses, one or more aliases, organization name, role classification, and/or timeline information associated with the entity. In some embodiments, the database 118 includes a social network knowledge graph, as described below with respect to FIG. 4. The social network knowledge graph may include relationships between known entities (including those derived from analyzing the ingested documents 105). Additionally, the entity objects 330 may include links and/or references to related fact objects derived from the ingested documents 105. The entity and role module 132 may then update the entity identification prompt with the retrieved metadata.

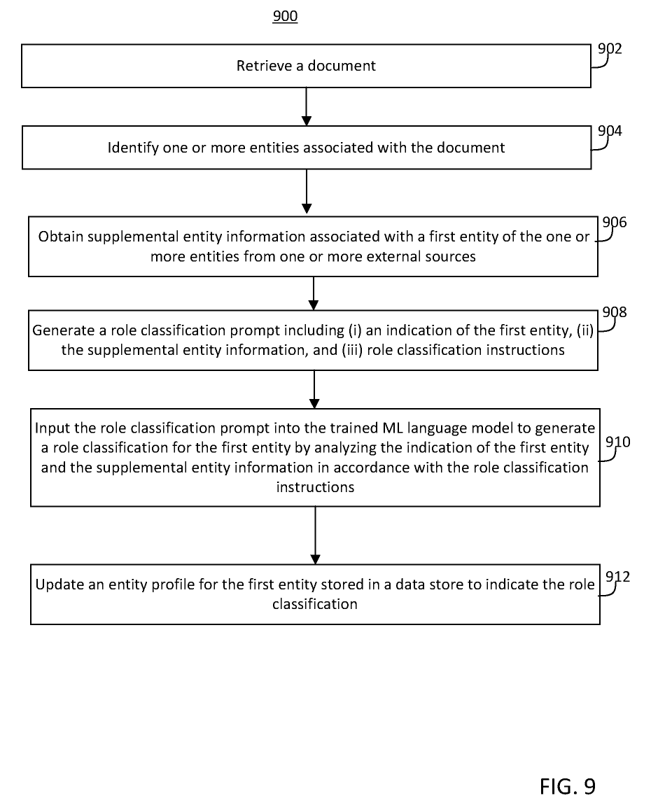

In some embodiments, the entity and role module 132 may detect an entity object 330 is missing relevant data. Responsive to detecting that the entity object 330 is missing relevant data, the entity and role module 132 may obtain supplemental entity information, from one or more external sources. As used herein, “supplemental entity information” refers to information about an entity obtained from sources external to the document being analyzed, such as web pages, organization charts, legal bar directories, and/or professional networking sites. In some embodiments, the entity and role module 132 obtains the supplemental entity information by scraping web page text from one or more web pages associated with the entity and/or generating a query to a RAG system to identify additional documents and/or workspace objects associated with the entity, as described below with respect to FIG. 9. In some embodiments, the entity and role module 132 generates the query based on the entity and one or more aliases associated with the entity from the entity profile.

The entity and role module 132 may use the presence or absence of a legal disclaimer 320 to determine the role of an entity. In some embodiments, the entity and role module 132 parses semantic content of the email signature 322 (e.g., the signature block) to identify one or more entities and determine the name, title, organization name, and/or other information about the entity from the email signature 322, as described below with respect to FIG. 9.

The entity identification prompt may include excerpts of the scrubbed text 324 and/or metadata 326, the identified names, email addresses, and/or other references, and instructions to identify one or more entities. The entity and role module 132 may supply the entity identification prompt to the ML language model 170 and receive a response, including identified entities, from the ML language model 170.

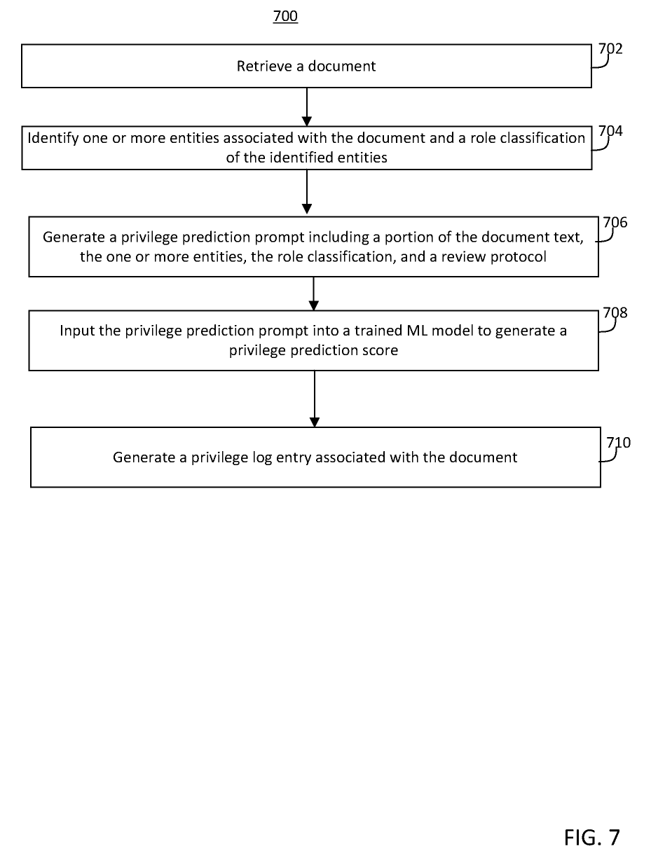

FIG. 3D depicts an exemplary process 300D associated with privilege prediction and logging. The privilege prediction and logging module 134 receives as input the scrubbed text 324 and metadata 326. The privilege prediction and logging module 134 may truncate and/or summarize metadata 326 that exceeds a size threshold, as described below with respect to FIG. 7. In some embodiments, the privilege prediction and logging module 134 receives as input parent information 328. The parent information 328 may include a privilege score and/or explanation for a parent email, e.g., an email enclosing an attachment or an earlier email in an email thread. In some embodiments, the privilege prediction and logging module 134 receives as input the entities 330 and roles 332.

The privilege prediction and logging module 134 generates a privilege prediction prompt from the inputs using retrieval techniques to supplement prompt criteria with data associated with the identified entity objects 330. The prompt criteria within the privilege prediction prompt may include a review protocol, privilege determination instructions, privilege log entry generation instructions, a scoring rubric, and/or other relevant instructions to the ML language model 170.

In some embodiments, the privilege prediction prompt may be a few shot prompt that contains one or more examples of privileged text, privilege breakers, and/or privilege log entries. An example of a privilege breaker is privileged text that is disclosed to a third-party. The privilege prediction and logging module 134 may determine that the disclosed email thread and any included attachments, including any potentially privileged language, are non-privileged due to the presence of the privilege breaker. The privilege prediction and logging module 134 may determine that non-disclosed, e.g., more recent emails occurring after the privilege breaker, remain privileged. In some embodiments, the privilege prediction prompt may include privilege determination instructions and/or few shot examples customized for a specified jurisdiction.

For example, the privilege prediction prompt may include jurisdiction-specific rules (e.g., attorney-client privilege requirements under U.S. federal law, state-specific privilege rules, or privilege rules under foreign jurisdictions). In some embodiments, the privilege prediction and logging module 134 identifies the applicable jurisdiction based on document metadata (e.g., sender and recipient locations, document origin, or matter-specific jurisdiction settings stored in the matter knowledge base 146). In some embodiments, the privilege prediction prompt includes privilege rules for multiple jurisdictions, and the ML language model 170 generates privilege predictions for each applicable jurisdiction.

The privilege prediction and logging module 134 provides outputs received from the ML language model 170 in response to inputting the privilege prediction prompt. For example, the privilege prediction and logging module 134 may output potentially privileged text 340. The potentially privileged text 340 may be the entirety or an excerpt of language providing or reflecting legal advice. The privilege prediction and logging module 134 may output potential privilege breakers 342. The privilege prediction and logging module 134 outputs a privilege category, score, and explanation 344. The privilege category, score, and explanation 344 may include the predicted privilege category, e.g., attorney-client, work product, bank examiner, joint defense, common interest, etc. The score may be a number, e.g., 0-5, or letter grade indicating the predicted likelihood that the document is privileged. For example, the scoring rubric may be 0 for junk document, 1 for not privileged, 2 for includes privileged individuals, 3 for uncertain, 4 for privileged redaction, and 5 for wholly privileged. The explanation may include a short explanation for why the ML language model 170 predicted that the document is privileged. The privilege prediction and logging module 134 may output a privilege log entry 346 for documents satisfying a score threshold. The privilege log entry 346 may include the type of communication or document, a description of the legal content, and a communication or document summary.

FIG. 3E depicts an exemplary process 300E associated with family-level privilege analysis. The privilege prediction and logging module 134 may receive as input an indication of a document family 348 comprising a plurality of related documents. In some embodiments, a user manually selects the document family 348 (e.g., by interacting with a user interface element when viewing a member of the document family 348). In other embodiments, the document retrieval and extraction module 130 identifies the document family 348 by sequentially processing a list of family identifiers. As used herein, a “document family” may include two or more documents that are associated with one another, such as by a shared communication thread, an attachment relationship, a parent-child linkage, or another document relationship. The document family 348 may comprise at least one of: (i) an email thread comprising a plurality of email messages, (ii) an email message and one or more attachments to the email message, or (iii) a parent document and one or more child documents linked to the parent document.

The privilege prediction and logging module 134 may generate respective privilege prediction prompts 350 for each document of the document family 348, as described above with respect to FIG. 3D, input the respective privilege prediction prompts 350 into the ML language model 170 to generate respective privilege prediction scores 352 for each document of the document family 348 based on independent analyses of the documents. The privilege prediction and logging module 134 may then re-assess the document family 348 by inputting a family review prompt into the ML language model 170 to generate a new privilege assessment (and/or update the privilege score output during the initial pass) for the individual documents based on the relationship to the other family members. The family review prompt may include the privilege outputs (including the scores 352) from the initial pass, a description of the family relationship, and rules for how privilege transfers between documents. It should be appreciated that the rules may define role-based privilege transfer, as well as subject matter-based privilege transfer. As explained above, this enables the privilege prediction and logging module 134 to be able to detect sources of privilege that cannot be definitively ascribed to a document based on a review of the document itself and to generate corresponding privilege log explanations that describe such sources of privilege.

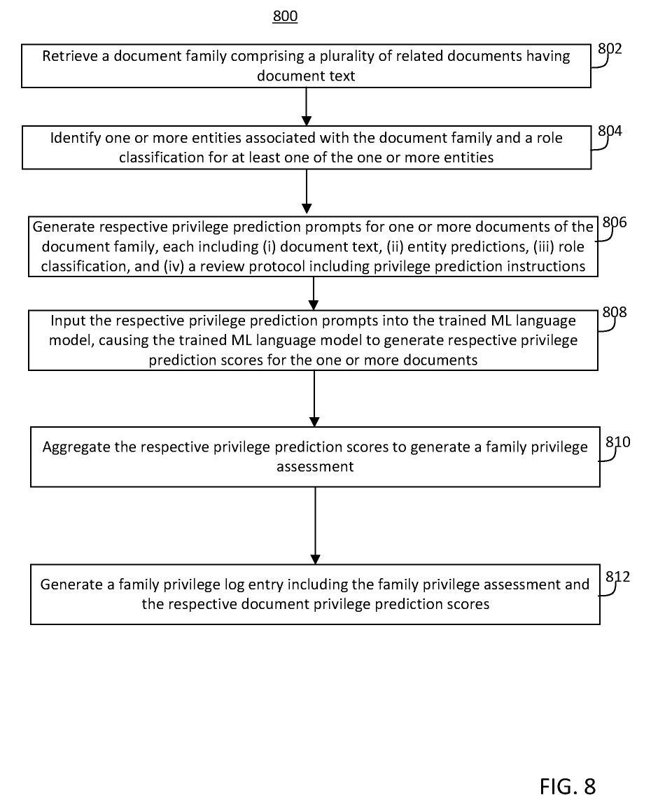

The privilege prediction and logging module 134 may generate privilege log entries 356 for the documents within the document family 348 based on the family privilege assessment 354 and respective document privilege indications for each document of the document family 348. In some embodiments, the privilege prediction and logging module 134 identifies a source document 358 within the document family 348 associated with privileged information indicated in the family privilege assessment 354 and updates the family privilege log entry 356 to include an indication of the source document 358. The privilege prediction and logging module 134 may identify the source document 358 by determining which document includes the highest respective privilege prediction score 352, by identifying the document containing the earliest instance of privileged communication, or by analyzing the propagation of privileged information across the document family 348, as described below with respect to FIG. 8.

### Example Social Network Knowledge Graph

FIG. 4 depicts an example social network knowledge graph 400. The social network knowledge graph 400 may be located in the universal knowledge base 142, client knowledge base 144, and/or the matter knowledge base 146.

The example social network knowledge graph 400 comprises a plurality of nodes 402A-402E, where a node represents an entity (such as entities associated with entity objects 330). The nodes 402A-402E may include data from the entity profile of the corresponding entity object 330 (e.g., the entity’s name, role, email addresses, telephone numbers, company or organization, and any other suitable information). The example social network knowledge graph 400 comprises a plurality of edges 404A-404F, wherein an edge represents a relationship between two nodes.

The entity and role module 132 may add nodes and edges to the social network knowledge graph 400 by identifying the senders and recipients of emails. In some embodiments, the entity and role module 132 may add nodes and edges to the social network knowledge graph 400 by analyzing an organization chart or identifying relationships between entities from a third-party site, such as LinkedIn. In some embodiments, the entity and role module 132 may generate the social knowledge graph 400 based on a frequency of communication with and/or about other entities.

The entity and role module 132 may utilize the social network knowledge graph 400 to identify ambiguous references to an entity in a document. For example, an email from Richard Smith to William Johnson may include a statement to “share the legal analysis memo with John.” The entity and role module 132, based on the sender and recipient email addresses, may identify Richard Smith as represented by node 402A and William Johnson as represented by node 402E. The entity and role module 132 may identify or create an edge 404C between node 402A and 402E, representing the relationship between the two entities. The entity and role module 132 may query the social network knowledge graph 400 with the name “John” and identify three potential matches: John Beck (node 402B), John Stevens (node 402C), and John Fisher (node 402D). To identify the most likely entity referred to as “John,” the entity and role module 132 may identify which nodes have a relationship with both node 402A and node 402E. Node 402B is connected to node 402E by edge 404D, node 402C is connected to node 402A by edge 404A, and node 402D is connected to node 402A by edge 404B and is connected to node 402E by edge 404F. Based on the connection to both node 402A and 402E, the entity and role module 132 may determine that “John” most likely refers to node 402D.

### Example Review User Interfaces

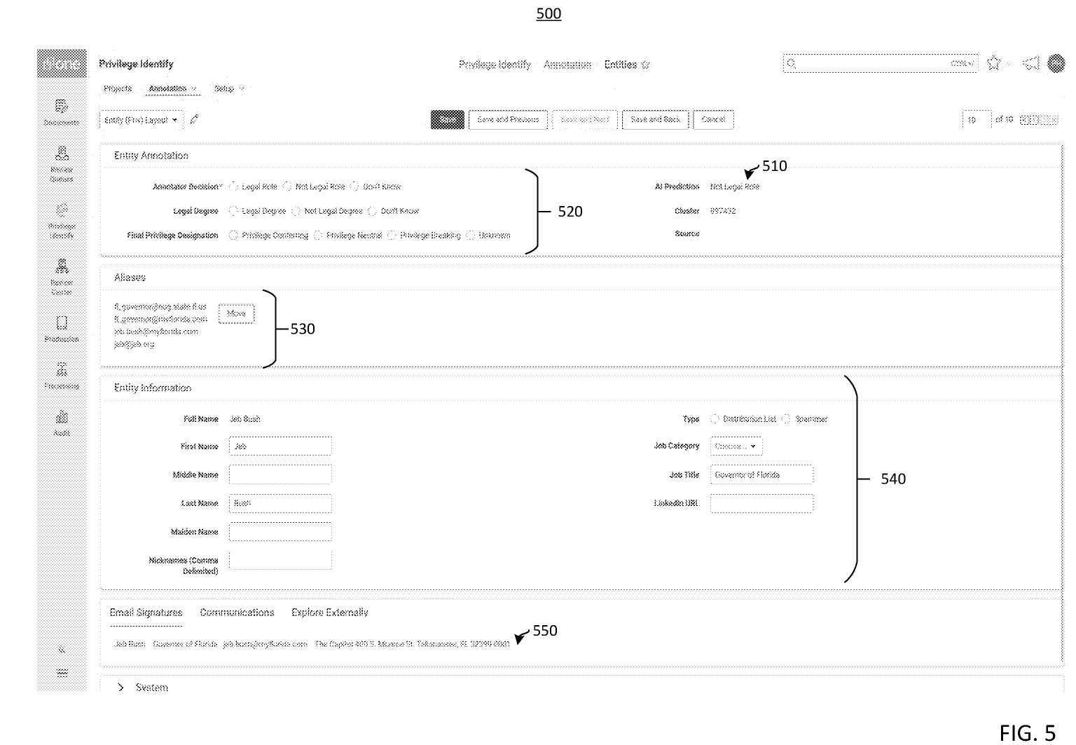

FIG. 5 depicts an example entity review user interface 500. In alternative embodiments, the entity review user interface 500 includes more and/or different inputs and outputs than those shown in FIG. 5. The entity review user interface 500 enables human reviewers to view, modify, and/or supplement AI-generated entity and role predictions. The review platform module 140 may present the entity review user interface 500 via the user device 160.

In some embodiments, the entity review user interface 500 presents the AI role prediction 510. The AI role prediction 510 may include the role 332 generated by the entity and role module 132, such as Not Legal Role. The entity review user interface 500 may present an entity annotation section 520. The entity annotation section 520 allows a human review to manually specify a role, a legal degree, and/or a privilege conferring status. The entity review user interface 500 may present aliases 530 for the entity. Aliases 530 include nicknames and/or additional email addresses associated with the entity. The human reviewer may add, delete, or change the aliases 530 predicted by the entity and role module 132.

The entity review user interface 500 may present entity information 540 for the entity. Entity information 540 includes node information in the social network knowledge graph 400. The entity and role module 132 may collect the entity information 540 from one or more information sources, including reviewed documents, organization charts, firm websites, etc. The human reviewer may supplement and/or modify entity information 540 via the entity review user interface 500. In some embodiments, the entity review user interface 500 presents an email signature 550 associated with the entity. The email signature 550 may include the email signature 322 identified by the document retrieval and extraction module 130. It should be appreciated that the information provided via the entity review user interface 500 may be maintained at the corresponding entity object 330 for the current entity.

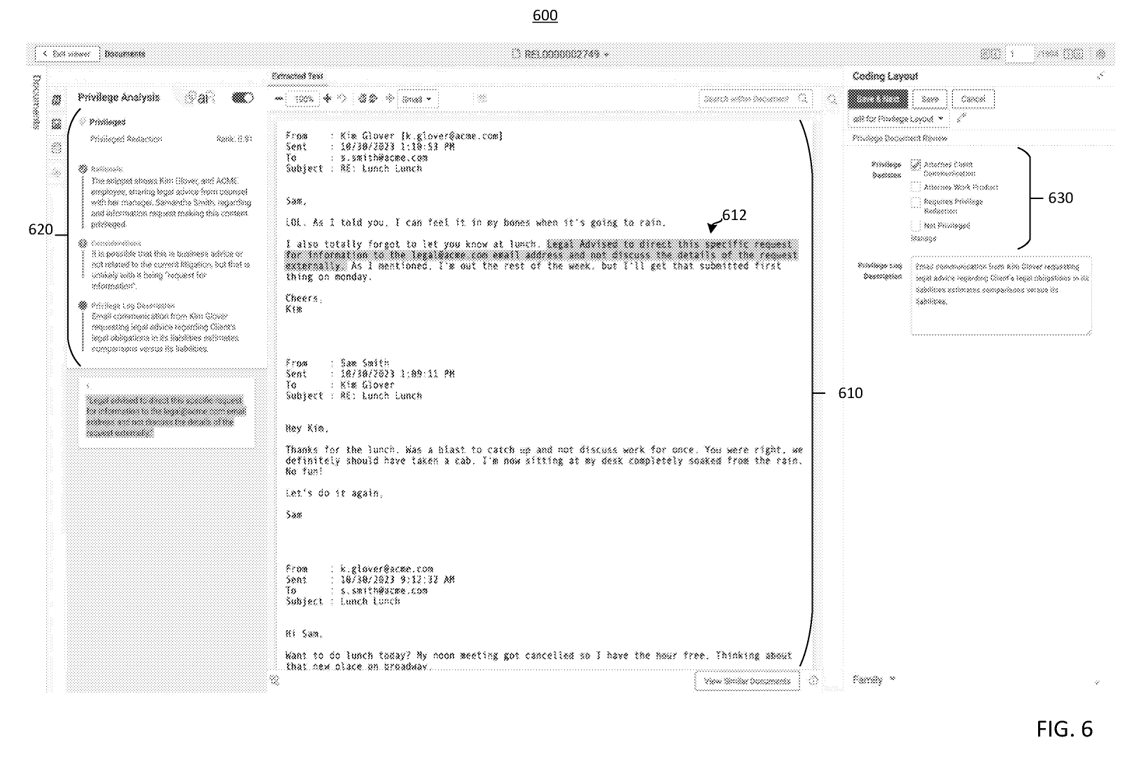

FIG. 6 depicts an example privilege review user interface 600. In alternative embodiments, the privilege review user interface 600 includes more and/or different inputs and outputs than those shown in FIG. 6. The privilege review user interface 600 enables human reviewers to view, modify, and/or supplement AI-generated privilege status predictions and privilege log entries. The review platform module 140 may present the privilege review user interface 600 via the user device 160.

In some embodiments, the privilege review user interface 600 presents document text 610. The document text 610 may include scrubbed text 324, as well as legal disclaimers 320 and/or email signatures 322. The document text 610 may include one or more potentially privileged snippets 612. The potentially privileged snippets 612 may include the potentially privileged text 340 flagged by the privilege prediction and logging module 134. The privilege review user interface 600 may highlight, mark, or otherwise visually annotate the potentially privileged snippets 612. The privilege review user interface 600 may include an option to redact the potentially privileged snippets 612. The document text 610 may include a potential privilege breaker (not illustrated). The potential privilege breaker may include the potential privilege breakers 342 flagged by the privilege prediction and logging module 134. The privilege review user interface 600 may highlight, mark, or otherwise visually annotate the potential privilege breaker. The human review may approve or reject the identified potentially privileged snippets 612 and/or potential privilege breaker.

In some embodiments, the privilege review user interface 600 includes a privilege explanation 620. The ML language model 170 may generate the privilege explanation 620. In the illustrated example, the privilege explanation 620 includes a privilege rationale, privilege consideration, and privilege log entry. The human reviewer may modify the privilege log entry.

In some embodiments, the privilege review user interface 600 includes a privilege decision section 630. The privilege decision section 630 may present the privilege category, score, and explanation 344 output by privilege prediction and logging module 134. The human reviewer may modify the privilege decision via the privilege decision section 630.

### Example Method of Automated Privilege Review

Each of the method 700, method 800, and method 900 as described below with respect to FIGS. 7-9 may operate as a stand-alone method, and/or may operate in conjunction with embodiments of at least a portion of the environment 100 and of any one or more components and/or devices related thereto, and/or with other systems, processors, databases and/or devices. For example, the workspace 110, including one or more of the document retrieval and extraction module 130, entity and role module 132, privilege prediction and logging module 134, and review platform module 140 may execute at least a portion of the method 700. In some embodiments, the workspace 110 may execute at least a portion of the method 700 in conjunction with one or more other components of the environment 100, such as the database 118, user device 160, and/or ML language model 170. Further, each method may include additional or alternate steps other than those described with respect to the corresponding FIGURE . It should be understood that not all blocks of method 700, method 800, and method 900 are required to be performed. Moreover, the methods are not mutually exclusive (i.e., block(s) from one method may be performed in any particular implementation).

FIG. 7 depicts a flow diagram of an example computer-implemented method 700 for automated privilege review. At block 702, the one or more processors retrieve a document having document text. The document may include a standalone document, an email message, or an attachment to a parent document. The document retrieval and extraction module 130 may retrieve the document from the corpus of documents 105 and/or be invoked as part of a document ingestion workflow.

In some embodiments, the document retrieval and extraction module 130 determines that the document is an electronic message. In these embodiments, the document retrieval and extraction module 130 may generate an electronic signature prompt including (i) the document text, (ii) exemplary electronic signature language, and (iii) signature identification instructions; and input the electronic signature prompt into the trained ML language model, thereby causing the trained ML language model to determine whether the document text comprises one or more electronic signatures or define one or more segments of the document corresponding to the one or more electronic signatures. In some embodiments, the privilege prediction and logging module 134 generates a privilege prediction prompt that includes an indication of the defined one or more segments of the document.

At block 704, the one or more processors identify one or more entities associated with the document and a role classification for at least one entity of the one or more entities. For example, the entity and role module 132 may identify entities from an email sender and one or more email recipients. The entity and role module 132 may identify entities from names mentioned in the body of a document using NER. The entity and role module 132 may identify entities from document metadata, such as a document author. The entity and role module 132 may assign the identified entities a role. For example, the role classification may include: (i) legal role, and (ii) non-legal role.

In some embodiments, to identify the role of an identified entity, the entity and role module 132 may input (i) the at least one entity, and (ii) a role classification prompt to the trained ML language model, wherein the role classification prompt causes the trained ML language model to predict the role classification for each of the at least one entity. In these embodiments, the entity and role module 132 may scrape web page text from one or more web pages; and input the (i) the at least one entity and (ii) the role classification prompt, and (iii) the web page text to the trained ML language model. In other embodiments, the entity and role module 132 may search a data store to identify an entity object associated with an entity; and obtain the role classification from the identified entity object.

Based on the identified role classifications, the entity and role module 132 may store or update an entity object (such as an entity object 330) including: (i) the at least one entity, and (ii) the role classification in a data store for the at least one entity.

In some embodiments, the entity and role module 132 updates document metadata associated with the document based on the role classification. The entity and role module 132 may query the corpus of documents to identify a subset of documents having metadata referencing the entity and prioritize processing of the subset of documents ahead of other unprocessed documents in the corpus of documents. In these embodiments, the entity and role module 132 may also identify a relationship between a first entity of the one or more entities and a second entity of the one or more entities, update the social network graph to indicate the relationship between the first entity and the second entity, and/or determine a role classification for the second entity based on the relationship. The relationship may be identified based on one or more of: (i) co-occurrence of the first entity and the second entity as sender and recipient of an email message, (ii) co-occurrence of the first entity and the second entity within the same document or email thread, or (iii) an organizational relationship indicated in document metadata or an email signature. In some embodiments, the entity and role module 132 inputs the relationship between the first entity and the second entity, the role classification of the first entity, and contextual information from the document into the ML language model 170 to determine the role classification for the second entity.

At block 706, the one or more processors generate a privilege prediction prompt including (i) at least a portion of the document text, (ii) indications of the one or more entities associated with the document, (iii) at least a portion of respective entity profiles for the one or more entities, such as the role classification assigned to the at least one entity, and (iv) a review protocol. As used herein, a “review protocol” may include a set of instructions, examples, and/or guidelines provided to the trained ML language model to guide privilege analysis, and may include example privileged language, privilege prediction instructions, privilege log generation instructions, scoring rubrics, and/or privilege breaker identification instructions. The privilege prediction and logging module 134 may generate the privilege prediction prompt. In some embodiments, the review protocol includes example privileged language , privilege prediction instructions, and/or privilege log generation instructions. In some embodiments, the privilege prediction prompt includes example privilege breakers comprising disclosures to a third-party and privilege breaker instructions. In some embodiments, the privilege prediction prompt includes a privilege prediction score of a parent document. In some embodiments, the privilege prediction prompt includes document metadata. Responsive to determining that a size of the document metadata exceeds a size threshold, the privilege prediction and logging module 134 may truncate the document metadata. In some embodiments, the privilege prediction prompt includes document metadata associated with a parent document.

At block 708, the one or more processors input the privilege prediction prompt into a trained ML language model, causing the trained ML language model to generate a privilege prediction score indicative of whether the document includes privileged information. For example, the privilege prediction and logging module 134 may input the privilege prediction prompt into the ML language model 170. The privilege prediction score may be a numeric or letter score indicating the predicted likelihood of the document being privileged. In some embodiments, the privilege prediction and logging module 134 validates the privilege prediction score by inputting the privilege prediction score and validation criteria into the trained ML language model. The validation criteria may include consistency checks (e.g., whether the privilege prediction score is consistent with the identified entities and role classifications), confidence thresholds (e.g., whether the ML language model's confidence in the prediction exceeds a minimum threshold), and/or comparison with historical privilege determinations for similar documents stored in the knowledge bases 142-146. Responsive to determining that the privilege prediction score fails validation, the privilege prediction and logging module 134 may flag the document for manual review, generate a re-analysis prompt including additional context, and/or adjust the privilege prediction score based on the validation results.

In some embodiments, the trained ML language model identifies one or more snippets of potentially privileged text from the document text. In some embodiments, the trained ML language model determines whether the document text includes one or more privilege breakers. In some embodiments, inputting the privilege prediction prompt causes the trained ML language model to generate a privilege log entry associated with the document. The privilege log entry may include a privilege type classification, the one or more entities associated with the document, and a non-privileged summary of the at least a portion of the document text.

At block 710, the one or more processors generate a privilege log entry associated with the document, wherein the privilege log entry includes a privilege indication based on the privilege prediction score. It should be appreciated the method 700 may be performed with respect to a plurality of documents in a workspace. Accordingly, as additional documents are analyzed for a potential privilege claim, the corresponding information is added to the privilege log. As a result, the privilege log can be automatically generated for the entire corpus of documents 105.

In some embodiments, responsive to determining that the privilege prediction score satisfies a score threshold, the one or more processors output to a user a document identifier, an indicator that the document is potentially privileged, and/or the privilege prediction score. The document identifier may include a document filename, an email message subject, a Bates number, or an identifier generated by the environment 100. The indicator that the document is potentially privileged may include a color, icon, and/or text. The document identifier, potentially privileged indicator, and privilege prediction score may be output by the review platform module 140 and displayed on a user interface on the user device 160. In some embodiments, the review platform module 140 outputs the one or more snippets of potentially privileged text from the document text. In some embodiments, the review platform module 140 marks for redaction the one or more snippets of potentially privileged text from the document text. In some embodiments, the review platform module 140 outputs the one or more entities and/or the role classifications.

FIG. 8 depicts a flow diagram of an example computer-implemented method 800 for family-level automated privilege review. The method 800 extends the single-document privilege review of method 700 to analyze a collection of related documents as a unified family. At block 802, the one or more processors retrieve a document family comprising a plurality of related documents having document text, as described above with respect to FIG. 3E. The document retrieval and extraction module 130 may retrieve the document family from the corpus of documents 105 and/or be invoked as part of a document ingestion workflow. In the ingestion example, the documents may be retrieved as part of the ingestion. As one example, after performing an email threading process that assigns different email threads a family identifier, the ingestion process may sequentially process the ingested families of documents. As another example, the system may run an initial query for documents likely to subject to a privilege claim (e.g., by performing a query based on a law firm name) to identify responsive documents and sequentially process the families corresponding to the top search results. In some embodiments, when the one or more processors determine that a document is to be analyzed, the one or more processors may retrieve the documents from a long-term data store (e.g., a data lake) and store the documents in a local cache.

In some embodiments, the document retrieval and extraction module 130 determines that a document of the document family is an electronic message and extract a signature block of the electronic message, e.g., by generating an electronic signature prompt for input into the trained ML language model, as described above with respect to FIG. 7.

Following retrieval of the document family at block 802, at block 804, the one or more processors identify one or more entities associated with the document family and a role classification for at least one entity of the one or more entities. The entity and role module 132 performs entity identification and role classification as described with reference to FIG. 3C and role classification as described with reference to block 704 of FIG. 7. Unlike the single-document analysis of block 704, block 804 identifies entities across the plurality of related documents in the document family to ensure that the trained ML language model has sufficient context to understand the entire family. The entity and role module 132 may identify entities from email senders and recipients across the plurality of related documents, from names mentioned in the body of documents using NER, and/or from document metadata such as document authors, as described with respect to block 704 of FIG. 7. The entity and role module 132 may assign the identified entities a role classification, such as legal role or non-legal role.

Following identification of entities and role classifications at block 804, at block 806, the one or more processors generate respective privilege prediction prompts for each document of the document family, as described with reference to FIG. 3E. A respective privilege prediction prompt may include (i) at least a portion of the document text, (ii) indications of the one or more entities associated with the document family, (iii) the role classification assigned to at least one entity, and (iv) a review protocol including privilege prediction instructions, as described with reference to block 706. In some embodiments, a respective privilege prediction prompt for at least one document of the document family includes a privilege prediction output of a preceding document of the document family. As used herein, a "preceding document" may refer to a document of the document family that is associated with an earlier position relative to a current document, such as by chronological order, hierarchical relationship, and/or processing sequence. The processing order may be determined based on at least one of: (i) a chronological ordering of the documents (e.g., earlier emails in an email thread are processed before later emails in the email thread), (ii) a hierarchical ordering (e.g., a parent document is processed before its child documents or attachments), or (iii) a privilege-score-based ordering (e.g., documents with higher preliminary privilege indicators are processed before documents with lower preliminary privilege indicators).

At block 808, the one or more processors input the respective privilege prediction prompts into the trained ML language model, causing the trained ML language model to generate respective privilege prediction scores for each document of the document family. The privilege prediction and logging module 134 may input the respective privilege prediction prompts into the ML language model 170. A respective privilege prediction score may be a numeric or letter score indicating the predicted likelihood of the corresponding document being privileged. The trained ML language model may generate outputs as described with reference to block 708 of FIGS. 7 and 3D for one or more documents of the document family. In some embodiments, the trained ML language model identifies one or more snippets of potentially privileged text from the document text of one or more documents of the document family, and the privilege prediction and logging module 134 outputs the one or more snippets of potentially privileged text. In some embodiments, the trained ML language model determines whether the document text of any document of the document family includes one or more privilege breakers, such as disclosures to a third-party.

At block 810, the one or more processors aggregate the respective privilege prediction scores to generate a family privilege assessment. For example, the one or more processors may compile the respective privilege predictions and/or any other derived context from the initial review for the individual documents within the family into a prompt to perform a second pass analysis via the trained ML model. The prompt may define rules for how relational context impacts the privilege assessment for related documents. For example, if a communication early in a communicate chain relates to an attorney direction to generate a work product, the family-based review can detect that an attachment to a later communication is generated responsive to the request, even if there are no indicators in the attachment that would otherwise indicate that the document is subject to an attorney work product privilege. As another example, an earlier communication may refer to a person by their first name, and a later communication may provide the context necessary to associate that person as belonging to a legal role. Thus, the family review can detect the attorney-client privilege for the earlier document, even though the initial pass based on just the document itself did not have sufficient context to identify the privilege basis.

At block 812, the one or more processors generate a family privilege log entry including the respective privilege prediction scores for the documents within the family, as described above with respect to FIG. 3E. In some embodiments, the family privilege log entry includes respective document privilege indications for each document of the document family as generated and/or adjusted during the analysis performed at block 810. In some embodiments, the privilege prediction and logging module 134 identifies a source document within the document family associated with privileged information indicated in the family privilege assessment and updates the family privilege log entry to include an indication of the source document. As used herein, a "source document" may refer to a document within a document family that is associated with the origin of privileged information, such as the document containing the initial request for legal advice, the document containing the initial provision of legal advice, the document having the highest respective privilege prediction score, and/or the document that is chronologically or hierarchically earliest among documents having privilege prediction scores satisfying a threshold. The privilege prediction and logging module 134 may identify the source document by determining which document of the document family includes the highest respective privilege prediction score, by identifying the document containing the earliest instance of privileged communication within the document family, and/or by analyzing the propagation of privileged information across the document family, as described below.

The privilege prediction and logging module 134 may identify the source document 358 by analyzing the propagation of privileged information across the document family 348. In some embodiments, to analyze the propagation of privileged information, the privilege prediction and logging module 134 determines a chronological ordering and/or hierarchical relationships of documents within the document family and evaluates the respective privilege prediction scores in view of the determined ordering and relationships. For example, if a parent email in an email thread has a high privilege prediction score and a subsequent child email forwarding or replying to the parent email also has a high privilege prediction score, the privilege prediction and logging module 134 may determine that the parent email is the source document from which privileged information propagated to the child email. As another example, if an email message has a high privilege prediction score and an attachment to the email message also has a high privilege prediction score, the privilege prediction and logging module 134 may determine that the email message is the source document based on the hierarchical relationship between the email message and the attachment. In some embodiments, the privilege prediction and logging module 134 inputs the respective privilege prediction scores and document relationship metadata (e.g., parent-child relationships, chronological ordering, sender-recipient information) into the ML language model 170 to identify the source document.

In some embodiments, responsive to determining that a respective privilege prediction score for a document of the document family satisfies a score threshold, the one or more processors output to a user via a display a document identifier, an indicator that the document is potentially privileged, and/or the respective privilege prediction score. As described with reference to block 710 of FIG. 7, the review platform module 140 may display the document privilege log entry on a user interface on the user device 160, including the respective document privilege indications for each document of the document family.

FIG. 9 depicts a flow diagram of an example computer-implemented method 900 for prompt-based role identification. The method 900 focuses on determining role classifications for entities identified within documents, which may be performed as a standalone workflow or as part of the privilege review methods 700 and 800. At block 902, the one or more processors retrieve a document. The document retrieval and extraction module 130 may retrieve the document from the corpus of documents 105, as described with reference to block 702 of FIG. 7.

Following retrieval of the document at block 902, at block 904, the one or more processors identify one or more entities associated with the document. The entity and role module 132 analyzes at least one of semantic content or document attributes of the document to identify the one or more entities. For example, the entity and role module 132 may identify entities from email senders and recipients, names mentioned in the body of a document using NER, and document metadata such as a document author, as described with reference to FIG. 3C. In some embodiments, the document comprises an electronic message having a signature block, and the entity and role module 132 parses semantic content of the signature block to identify the one or more entities.

At block 906, the one or more processors obtain supplemental entity information associated with a first entity of the one or more entities from one or more external sources. As used herein, "supplemental entity information" refers to information about an entity obtained from sources external to the document being analyzed, such as web pages, organization charts, legal bar directories, professional networking sites, corporate filings, court records, news articles, and/or information retrieved from a RAG system. Supplemental entity information may include role indicators, organizational affiliations, professional credentials, employment history, and/or relationships with other entities. The entity and role module 132 may scrape web page text from one or more web pages associated with the first entity. In some embodiments, the entity and role module 132 generates a query based on the first entity, transmits the query to a RAG system to identify additional documents and/or workspace objects associated with the entity, and receives the additional documents and/or workspace objects from the RAG system in response to the query. In some embodiments, the entity and role module 132 generates the query based on the first entity and one or more aliases associated with the first entity from the entity profile.

After obtaining the supplemental entity information at block 906, at block 908, the one or more processors generate a role classification prompt including (i) an indication of the first entity, (ii) the supplemental entity information, and (iii) role classification instructions. The entity and role module 132 may generate the role classification prompt. The role classification instructions may instruct the trained ML language model how to analyze the indication of the entity, the supplemental entity information, and/or semantic content of the document to determine the role classification.

At block 910, the one or more processors input the role classification prompt into the trained ML language model, causing the trained ML language model to generate a role classification for the first entity by analyzing the indication of the first entity and the supplemental entity information in accordance with the role classification instructions. The entity and role module 132 may input the role classification prompt into the ML language model 170. The role classification may indicate whether the first entity is associated with at least one of a legal role or a non-legal role, wherein the legal role includes at least one of outside counsel, in-house counsel, or opposing counsel, and wherein the non-legal role includes at least one of non-legal client employee, vendor, or third-party.

Following generation of the role classification at block 910, at block 912, the one or more processors update an entity profile for the first entity stored in a data store to indicate the role classification. The entity and role module 132 may store or update an entity object 330 including the first entity and the role classification. In some embodiments, the entity and role module 132 compares the role classification to an existing role classification in the entity profile and, responsive to determining that the role classification includes a higher likelihood of privilege association than the existing role classification, replaces the existing role classification with the role classification, as described above with respect to FIG. 7.

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for practicing the techniques disclosed herein through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

What is claimed:

1. A computer-implemented method for performing automated privilege review using a trained machine learning (ML) language model, comprising:
retrieving, by one or more processors, a document family comprising a plurality of related documents having document text;
identifying, by the one or more processors, one or more entities associated with the document family and a role classification for at least one of the entities;
generating, by the one or more processors, respective privilege prediction prompts for one or more documents of the document family, the respective privilege prediction prompts including (i) at least a portion of the document text, (ii) indications of the one or more entities, (iii) the role classification, and (iv) a review protocol including privilege prediction instructions;
inputting, by the one or more processors, the respective privilege prediction prompts into the trained ML language model, causing the trained ML language model to generate respective privilege prediction scores for the one or more documents;
aggregating, by the one or more processors, the respective privilege prediction scores to generate a family privilege assessment; and
generating, by the one or more processors, a family privilege log entry including the family privilege assessment and the respective privilege prediction scores.

2. The method of claim 1, wherein:
inputting the respective privilege prediction prompts into the trained ML language model further causes the trained ML language model to identify one or more snippets of potentially privileged text from the document text, and
the method further comprises:
outputting the one or more snippets of potentially privileged text; and
marking for redaction, by the one or more processors, the one or more snippets of potentially privileged text in the document.

3. The method of claim 1, wherein identifying the role classification for at least one entity of the one or more entities further comprises:
storing or updating an entity object including: (i) the at least one entity, and (ii) the role classification in a data store for the at least one entity.

4. The method of claim 3, wherein identifying the one or more entities associated with the document family comprises:
identifying, by the one or more processors, a relationship between a first entity of the one or more entities and a second entity of the one or more entities; and
updating, by the one or more processors, a social network graph to indicate the relationship between the first entity and the second entity.

5. The method of claim 1, wherein identifying the role classification comprises:
searching, by the one or more processors, a data store to identify an entity object associated with an entity; and
obtaining, by the one or more processors, the role classification from the identified entity object.

6. The method of claim 1, wherein identifying the role classification comprises:
inputting, by the one or more processors, (i) the at least one entity, and (ii) a role classification prompt to the trained ML language model, wherein the role classification prompt causes the trained ML language model to predict the role classification for each of the at least one entity.

7. The method of claim 6, wherein inputting the (i) the at least one entity and (ii) the role classification prompt comprises:
scraping, by the one or more processors, web page text from one or more web pages; and
inputting the (i) the at least one entity and (ii) the role classification prompt, and (iii) the web page text to the trained ML language model.

8. The method of claim 1, wherein the role classification includes: (i) legal role, and (ii) non-legal role.

9. The method of claim 1, wherein:
the respective privilege prediction prompts include instructions instructing the trained ML language model how to analyze the at least a portion of the document text and the one or more entities to generate at least one of (i) a privilege type classification and (ii) a non-privileged summary of the at least a portion of the document text.

10. The method of claim 1, further comprising:
responsive to determining that a respective privilege prediction score satisfies a score threshold, outputting, by the one or more processors and via a display, an indication indicating a document identifier, an indicator that a document of the document family is potentially privileged, and/or the respective privilege prediction score.

11. The method of claim 1, further comprising:
determining, by the one or more processors, that a document of the document family is an electronic message;
generating, by the one or more processors, an electronic signature prompt including (i) document text of the document, (ii) exemplary electronic signature language, and (iii) signature identification instructions; and
inputting, by the one or more processors, the electronic signature prompt into the trained ML language model, causing the trained ML language model to determine whether the document text comprises one or more electronic signatures or define one or more segments of the document corresponding to one or more electronic signatures.

12. The method of claim 11, wherein generating the respective privilege prediction prompts comprises:
inputting an indication of the defined one or more segments.

13. The method of claim 11, wherein:
at least one of the respective privilege prediction prompts further includes privilege breaker instructions instructing the trained ML language model how to determine whether the document text includes one or more privilege breakers.

14. The method of claim 1, further comprising:
extracting, by the one or more processors, document metadata associated with the documents of the document family and parent document metadata for documents linked to parent documents;
generating the respective privilege prediction prompts to include the document metadata and parent document metadata; and
responsive to determining that a size of the document metadata satisfies a size threshold, truncating the document metadata.

15. The method of claim 1, further comprising:
generating, by the one or more processors, at least one respective privilege prediction score based on cross-document relationships by inputting a privilege prediction output of a preceding document in the document family into a respective privilege prediction prompt for a subsequent document.

16. The method of claim 1, wherein generating the respective privilege prediction prompts comprises:
including, in a respective privilege prediction prompt for at least one document of the document family, a privilege prediction output of a preceding document of the document family.

17. The method of claim 1, wherein the document family comprises at least one of: (i) an email thread comprising a plurality of email messages, (ii) an email message and one or more attachments to the email message, or (iii) a parent document and one or more child documents linked to the parent document.

18. The method of claim 1, further comprising:
querying, by the one or more processors, a knowledge base to retrieve privilege-related information associated with at least one of the one or more entities, wherein the knowledge base comprises at least one of a universal knowledge base, a client knowledge base, or a matter knowledge base; and
including, by the one or more processors, the privilege-related information in at least one of the respective privilege prediction prompts.

19. A system for performing automated privilege review using a trained machine learning (ML) language model, the system comprising:
one or more processors; and
one or more non-transitory memories storing computer-executable instructions that, when executed by the one or more processors, causes the system to:
retrieve a document family comprising a plurality of related documents having document text;
identify one or more entities associated with the document family and a role classification for at least one of the entities;
generate respective privilege prediction prompts for one or more documents of the document family, the respective privilege prediction prompts including (i) at least a portion of the document text, (ii) indications of the one or more entities, (iii) the role classification, and (iv) a review protocol including privilege prediction instructions;
input the respective privilege prediction prompts into the trained ML language model, causing the trained ML language model to generate respective privilege prediction scores for the one or more documents;
aggregate the respective privilege prediction scores to generate a family privilege assessment; and
generate a family privilege log entry including the family privilege assessment and the respective privilege prediction scores.

20. A non-transitory computer-readable medium storing computer-executable instructions for performing automated privilege review using a trained machine learning (ML) language model, wherein the computer-executable instructions, when executed by one or more processors, cause the one or more processors to:
retrieve a document family comprising a plurality of related documents having document text;
identify one or more entities associated with the document family and a role classification for at least one of the entities;
generate respective privilege prediction prompts for one or more documents of the document family, the respective privilege prediction prompts including (i) at least a portion of the document text, (ii) indications of the one or more entities, (iii) the role classification, and (iv) a review protocol including privilege prediction instructions;
input the respective privilege prediction prompts into the trained ML language model, causing the trained ML language model to generate respective privilege prediction scores for the one or more documents;
aggregate the respective privilege prediction scores to generate a family privilege assessment; and
generate a family privilege log entry including the family privilege assessment and the respective privilege prediction scores.
